(19) United States
(12) Patent Application Publication
(10) Pub. No.: US 2008/0074902 A1
(43) Pub. Date: Mar. 27, 2008

(54) LCD BACKLIGHT ASSEMBLY WITH LEDS

(75) Inventors: Jeong Seok Oh, Seoul (KR); Young Bee Chu, Suwon-Si (KR); Sang Hee Lee, Yongin-Si (KR); Sung Min Kim, Yongin-Si (KR); Jeung Soo Kim, Seoul (KR)

Correspondence Address: MacPHERSON KWOK CHEN & HEID LLP, Suite 226, 1762 Technology Drive, San Jose, CA, 95110, US

(73) Assignee: SAMSUNG ELECTRONICS CO., LTD., Suwon-Si (KR)

(21) Appl. No.: 11/859,969

(22) Filed: Sep. 24, 2007

(30) Foreign Application Priority Data
Sep. 25, 2006 (KR) 10-2006-0092894

(51) Int. Cl. F21V 8/00; F21V 7/04

(52) U.S. Cl. 362/612; 362/613

(57) ABSTRACT

An edge type backlight assembly for an LCD includes a plurality of flexible printed circuit boards, each of which has a group of one or more LEDs mounted thereon and disposed adjacent to each other. If one of the LEDs is defective, only the board on which the defective LED is mounted needs to be replaced, thereby simplifying rework of the backlight assembly and reducing its manufacturing cost. Further, by coupling separate sources of power to the separate LED mounting boards, the amount of light emitted by separate regions of the display can be independently controlled.

### RELATED APPLICATIONS

This application claims priority of Korean Patent application No. 10-2006-0092894, filed Sep. 25, 2006, the entire disclosure of which is incorporated herein by reference.

### BACKGROUND

This disclosure relates to liquid crystal displays (LCDs), in general, and in particular, to LCD backlight assemblies in which light emitting diodes (LEDs) are used as the light source and in which individual defective LEDs are easily replaced.

LCDs are a widely used type of flat panel display that displays images by changing the alignment of liquid crystals in each of a plurality of pixels of the display to adjust the amount of light transmitted thereby. Since LCDs are not self-luminous, a backlight assembly is typically provided behind the liquid crystal panel of the display to radiate light through the panel.

Recently, backlight assemblies have been developed that use light emitting diodes (LEDs) as the light sources thereof. The use of LEDs in this application is advantageous in that they are relatively thin, light in weight, and have a long lifespan and a low power consumption in comparison to other types of light sources. In order to make the LEDs as thin and light as possible, the backlight assemblies are provided with a LED lamp unit in which a plurality of LEDs are mounted on a flexible printed circuit board (PCB). However, this creates a problem in that, if only one the plurality of LEDs on the PCB is defective, the entire LED lamp unit must be replaced. Further, since electrical power is supplied to all of the LEDs on the flexible PCB simultaneously, it is difficult to drive the LEDs individually to selectively adjust the light output in different areas of the lamp unit.

### BRIEF SUMMARY

In accordance with the exemplary embodiments thereof described herein, backlight assemblies for LCDs are disclosed in which a plurality of mounting boards, each mounting one or more LEDs, are separately provided for the selective replacement of defective LED regions of the backlight assembly, which reduces manufacturing costs by enabling defective backlight assemblies to be easily reworked. Further, separate power supplies are individually supplied to the separate mounting boards, thereby enabling the amount of light emitted by each region to be selectively and independently adjusted.

In one exemplary embodiment, a backlight assembly comprises a light source unit that includes LEDs that emit light and a plurality of mounting boards on each of which a group, comprising at least one of the LEDs, is mounted, a light guiding plate disposed adjacent to the light source unit, and a housing member within which the light source unit and the light guiding plate are accommodated.

The mounting boards may comprise a printed circuit board or a flexible printed circuit board. Each of the mounting boards may include mounting portions, on which the LEDs are mounted, and extensions that extend outward from the mounting portions. In this embodiment, the mounting board extensions may be arranged such that at least a part of the extensions overlaps or is disposed adjacent to at least one extension of another mounting board.

The mounting boards may be disposed adjacent to one side wall of the light guiding plate. If the unit length of the one side wall of the light guiding plate is 1, the unit length of each of the mounting boards is preferably 0.01 to 0.9 unit lengths, and the total unit length of the plurality of mounting boards is preferably 0.9 to 1.1 unit lengths.

The group of LEDs respectively mounted on each mounting board is preferably individually driven, and the LEDs may emit white light, and may be connected to the mounting boards in series, in parallel, or both in series and in parallel with each other.

The housing member may include a housing space within which the light guiding plate is accommodated, and a lamp connecting unit provided at one edge of the housing space and connected to the light source unit. The plurality of LED mounting boards may be attached to an upper side of the lamp connecting unit, and the LEDs that are mounted on the boards may pass through the lamp connecting unit to the interior thereof so as to be located adjacent to the light guiding plate. The light guiding plate preferably includes a plurality of light guiding plate portions corresponding in number to the number of mounting boards.

In another exemplary embodiment, a display device comprises a backlight assembly that includes a light source unit having a plurality of mounting boards on which at least one LED is mounted, a light guiding plate disposed adjacent to the light source unit, a housing member in which the light source unit and the light guiding plate are accommodated, and a display panel that displays images using light emitted from the backlight assembly.

The backlight assembly may further include a reflective plate disposed between the housing member and the light guiding plate, and an optical sheet disposed above the light guiding plate.

The mounting boards may each comprise a printed circuit board or a flexible printed circuit board, and the mounting boards may include mounting portions on which the LEDs are mounted and extensions that extend away from the mounting portions. The display device preferably includes at least one LED controller that is connected to the light source unit to controllably couple the output of a power supply to the LEDs. Preferably, the power supply is coupled to each of the individual mounting boards through a separate LED controller.

The housing member preferably includes a housing space within which the light guiding plate is accommodated, and a lamp connecting unit disposed at one edge of the housing space and connected to the light source unit. The plurality of mounting boards are preferably attached to an upper side of the lamp connecting unit, and the LEDs on the mounting boards pass through the lamp connecting unit and into the interior thereof so as to be located adjacent to the light guiding plate.

A better understanding of the above and many other features and advantages of the novel LCD backlight assembly of the present invention may be obtained from a consideration of the detailed description below of some exemplary embodiments thereof, particularly if such consideration is made in conjunction with the appended drawings, wherein like reference numerals are used to identify like elements illustrated in one or more of the figures thereof.

### BRIEF DESCRIPTION OF THE DRAWINGS

FIG. 1 is an exploded perspective view of a first exemplary embodiment of a backlight assembly in accordance with the present invention;

FIG. 2 is a plan view of the exemplary backlight assembly of FIG. 1;

FIG. 3 is a cross-sectional view of the backlight assembly of FIG. 1, as seen along the lines of the section A-A taken therein;

FIG. 4 is a cross-sectional view of an LED lamp unit of the exemplary backlight assembly of FIG. 1, as seen along lines of the section B-B taken therein;

FIG. 5 is a partial functional block diagram illustrating the process by which the LED lamp unit of FIG. 4 is electrically driven;

FIG. 6 is an exploded perspective view of an exemplary embodiment of an LCD incorporating the first exemplary backlight assembly of the invention;

FIG. 7 is a cross-sectional view of the LCD of FIG. 6, as seen along the lines of the section C-C taken therein;

FIG. 8 is an exploded perspective view of a second exemplary embodiment of a backlight assembly in accordance with the present invention; and,

FIG. 9 is a plan view of the second exemplary backlight assembly of FIG. 8.

FIG. 10 is an exploded perspective view of a third exemplary embodiment of a backlight assembly in accordance with the present invention.

### DETAILED DESCRIPTION

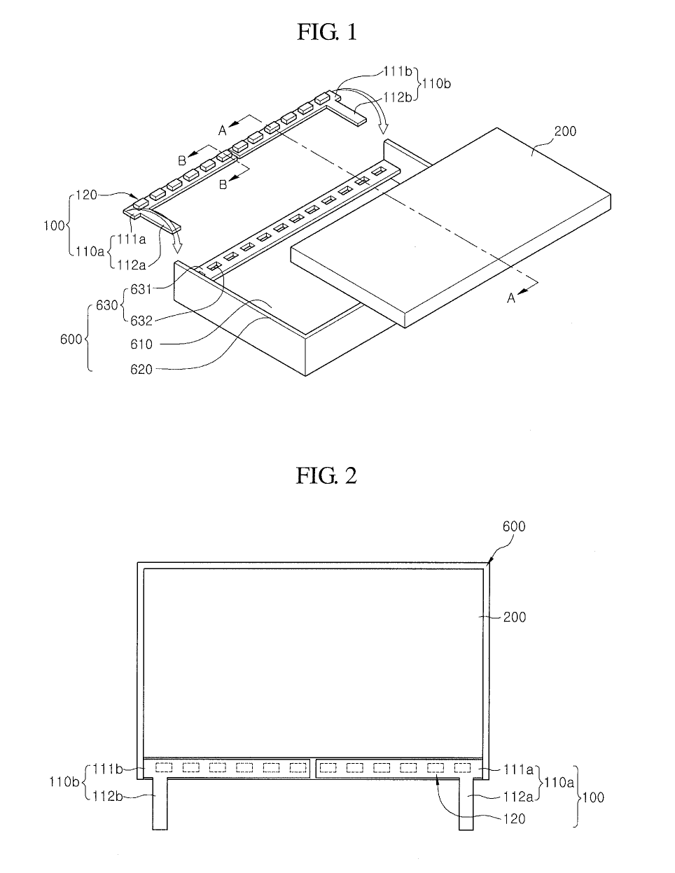

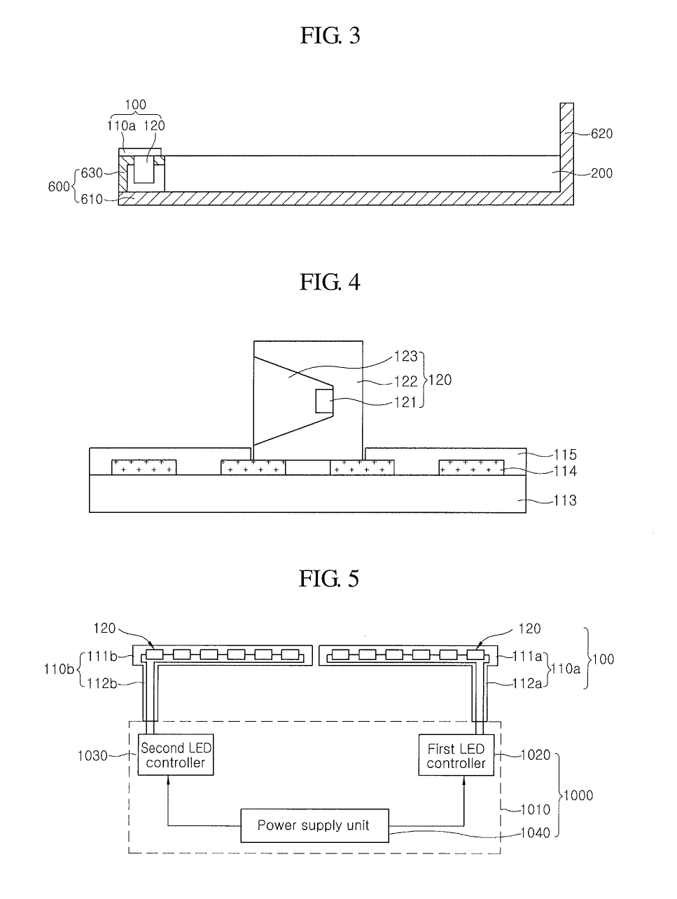

FIG. 1 is an exploded perspective view of a first exemplary embodiment of a backlight assembly in accordance with the present invention, FIG. 2 is a plan view of the exemplary backlight assembly, FIG. 3 is a cross-sectional view thereof, as seen along the lines of the section A-A taken in FIG. 1, FIG. 4 is a cross-sectional view of an exemplary LED lamp unit thereof, as seen along the lines of the section B-B taken in FIG. 1, and FIG. 5 is a partial functional block diagram illustrating the process by which the LED lamp unit of FIG. 4 is electrically driven.

Referring to FIGS. 1 to 5, the first exemplary backlight assembly includes a light guiding plate 200, an LED lamp unit disposed at one side of the light guiding plate 200, and a housing member 600 within which the light guiding plate 200 and the LED lamp unit 100 are accommodated.

The light guiding plate 200 of the first exemplary embodiment is rectangular, and functions to modulate light emitted from the LED lamp unit 100 that is distributed as a point source type of light into light that is distributed in a uniform, surface source type of light. The light guiding plate 200 is preferably formed of polymethylmethacrylate (PMMA) that has a high strength and good light transmittance. Due to its relatively high strength, the PMMA is not easily deformed or damaged, and further, enables optical patterns, such as prism patterns, to be formed readily on a surface of the light guiding plate 200.

The LED lamp unit 100 is disposed adjacent to at least one side wall of the light guiding plate 200. In this particular embodiment, the LED lamp unit 100 includes a plurality of mounting boards 110a and 110b on which at least one packaged LED 120 is mounted.

In prior art LED lamp units 100, a plurality of LEDs 120 are mounted on a single mounting board 110. Therefore, even when only one of the LEDs 120 is defective, the entire LED lamp unit 100 must be replaced to rework the backlight assembly. However, in the LED lamp unit 100 of the first exemplary embodiment, a plurality of LEDs 120 are mounted on a plurality of mounting boards 110. Therefore, if only one of the LEDs 120 is defective, only the mounting board 110 on which the defective LED package 120 is mounted needs to replaced so as to replace the defective LED 120, thereby reducing manufacturing costs and improving the efficiency of the rework process.

As illustrated in FIGS. 1 and 2, the LED lamp unit 100 of the first embodiment includes first and second mounting boards 110a and 110b, and a group of six LEDs 120 is mounted on each of the two substrates 110a and 110b. However, it should be understood that the invention is not limited to the particular exemplary embodiment illustrated, and the number of LEDs 120 that are mounted on a single mounting board 110 may be more than or less than six. Further, the number of LEDs 120 that are mounted on the mounting boards 110 may vary, depending on the respective lengths of the mounting boards 110. Furthermore, the number of mounting boards 110 is not limited to two, but may include more than two.

In the first exemplary embodiment, flexible printed circuit boards (PCBs) are preferably used as the first and second mounting boards 110a and 110b. However, it should be understood that the mounting boards 110a and 110b are not limited to flexible PCBs, and may comprise other types of PCBs. As illustrated in FIG. 4, each of the first and second mounting boards 110a and 110b includes a flexible base film 113, a metal wiring line 114 formed on the base film 113, and a protective film 115 formed over the base film that serves to protect the metal wiring line 114. In the embodiment illustrated in FIG. 4, portions of the protective film 115 are cut out to expose the metal wiring line 114 disposed below the protection film 115. The LEDs 120 are mounted on the portions of the metal wiring line 114 that are exposed through the cutouts.

Each of the first and second mounting boards 110a and 110b includes first and second mounting portions 111a and 111b on which the LEDs 120 are mounted, and first and second extensions 112a and 112b that extend out from the first and second mounting portions 111a and 111b. As illustrated in FIGS. 1 and 2, the first and second mounting portions 111a and 111b are formed with a rectangular rod shape that extends in a longitudinal direction of the housing member 600. The first and second mounting portions 111a and 111b are accommodated in a portion of the housing member 600 that is located adjacent to one side wall of the light guiding plate 120. In this exemplary embodiment, if the unit length of the one side wall of the light guiding plate 120 is assumed to be 1, the lengths of the first and second mounting portions 111a and 111b are preferably within the range of 0.01 to 0.9 unit lengths. Further, the minimum length of each of the first and second mounting portions 111a and 111b is preferably long enough to mount at least one packaged LED 120 thereon, and the maximum length of each of the first and second mounting portions 111a and 111b is preferably long enough to mount the LEDs 120 such that the at least one LED 120 thereon is disposed adjacent to the light guiding plate 200. The total length of the first and second mounting portions 111a and 111b is preferably between 0.9 to 1.1 unit lengths, i.e., the first and second mounting portions 111a and 111b may be arranged so as to be disposed immediately adjacent to or even to overlap each other.

The first extension 112a is located inboard of and extends in a direction parallel to a right edge of the first mounting portion 111a. The second extension 112b is located inboard of and extends in a direction parallel to a left edge of the second mounting portion 111b. However, the respective configurations of the extensions are not limited to those illustrated, and the first extension 112a may be disposed, e.g., at the immediate left edge of the first mounting portion 111a, and the second extension 112b may be disposed at the immediate right edge of the second mounting portion 111b. Further, the first and second extensions 112a and 112b may be disposed adjacent to each other so that at least portions of them overlap each other. As illustrated in FIG. 2, the first and second extensions 112a and 112b protrude outside of the housing member 600 so as to enable them to connect to an external system. Therefore, in a display device incorporating the first exemplary backlight assembly and in which the backlight assembly connects to an external system, the first and second extensions 112a and 112b may be spaced apart from, adjacent to, or may even overlap each other.

Each of the first and second mounting boards 110a and 110b may be formed as a single body having a single base and protective film 112 and 115. However, the first and second mounting boards 110a and 110b are not limited to this particular configuration, and may be formed such that each of the first and second mounting portions 111a and 111b, and the respective first and second extensions 112a and 112b thereof are formed as separate bodies.

Referring to FIG. 5, the plurality of LEDs 120 mounted on the first and second mounting boards 110a and 110b are connected electrically in series by the metal wiring lines 114 of the first and second mounting boards 110a and 110b. However, the electrical connection of the LEDs 120 is not limited thereto, and the LEDs 120 may be connected in series, in parallel or both in series and in parallel on either of the first and second mounting boards 110a and 110b.

As described above, the first and second extensions 112a and 112b of the first and second mounting boards 110a and 110b are respectively connected to an external system 1000. As illustrated schematically in FIG. 5, the external system 1000 may include a circuit board 1010, first and second LED controllers 1020 and 1030, and a power supply unit 1040. The first and second LED controllers 1020 and 1030 are each supplied with electrical power from the power supply unit 1040 to generate first and second control voltages. The external system 1000 may further include a control unit (not illustrated) that controls the operation of each of the first and second LED controllers 1020 and 1030 and the power supply unit 1040. In one exemplary embodiment, an electrical connector may be disposed at each of the respective ends of the first and second extensions 112a and 112b to facilitate their electrical connection to the circuit board 1010.

The first and second mounting boards 110a and 110b are respectively electrically connected to the first and second LED controllers 1020 and 1030. The group of LEDs 120 mounted on the first mounting board 110a is supplied with a first control voltage by the first LED controller 1020 so as to emit light, and the group of LEDs 120 mounted on the second mounting board 110b is supplied with a second control voltage by the second LED controller 1030 so as to emit light. Therefore, in the first exemplary embodiment, light is individually emitted from the groups of LEDs 120 respectively mounted on each of the first and second mounting boards 110a and 110b. That is, when the first and second control voltages are the same, the two groups of LEDs 120 respectively mounted on the first and second mounting boards 110a and 110b emit the same intensity of light. In contrast, when the first and second control voltages are different from each other, the two groups of LEDs 120 respectively mounted on the first and second mounting boards 110a and emit light of different intensities. Thus, in the first exemplary embodiment, the first and second mounting boards 110a and 110b are both physically and electrically independent of each other.

As discussed above, in the first embodiment, the two groups of LEDs 120 respectively mounted on each of the first and second mounting boards 110a and 110b emit light using the first and second LED controllers 1020 and 1030, respectively. However, this invention is not limited to such an arrangement, and in an alternative embodiment, the two groups of LEDs 120 respectively mounted on each of the first and second mounting boards 110a and 110b may individually emit light using only a single LED controller to control all of the LEDs. In yet another alternative embodiment, groups of the LEDs mounted on each of the each of the first and second mounting boards 110a and 110b may be separately controlled by two or more LED controllers.

Indeed, the number of LED controllers 1020 and 1030 of the external system 1000 may vary, depending on the number of LEDs 120 mounted on the first and second mounting boards 110a and 110b and the number of LEDs 120 that can be driven by a single LED controller 1020 or 1030. For example, when groups of six LEDs 120 are respectively mounted on each of the first and second mounting boards 110a and 110b, and a single LED controller 1020 or 1030 is capable of driving eight LEDs 120, as described above, each of the two groups of six LEDs is respectively driven using one of the two LED controllers 1020 and 1030. Further, when a single LED controller 1020 or 1030 is capable of driving, e.g., twelve LEDs 120, then both groups of six LEDs can be driven by only one of LED controller 1020 or 1030.

In the exemplary embodiment illustrated, the LEDs 120 respectively mounted on the first and second mounting board 110a and 110b are each respectively driven by the LED controllers 1020 and 1030. That is, the first LED controller 1020 supplies electrical power to the first mounting board 110a so as to drive the group of LEDs 120 mounted thereon, and the second control power supply 1030 supplies electrical power to the second mounting board 110b to drive the group of LEDs 120 mounted thereon. Thus, by using two controllers that are each capable of outputting different currents and voltages, the two groups of LEDs 120 respectively mounted on the first and second mounting boards 110a and 120 may be independently driven. Thus, the LED controllers 1020 and 1030 are each preferably capable of supplying a different control voltage to a respective one of each of the first and second mounting boards 110a and 110b.

As illustrated in FIG. 4, each of the LEDs 120 includes an LED chip 121 that emits light of a specific color and intensity, an LED mounting unit 122 on which the LED chip 121 is mounted, and a molded body 123 within which the LED chip 121 is encapsulated. An electrode unit (not illustrated) is further included to supply power to the LED unit 122. In one possible embodiment, the LED unit 122 may include a single LED chip 121 that emits white light due to a secondary excitation of a fluorescent substance. However, the LED units 122 are not limited thereto, and each of the LED units may include a plurality of LED chips that respectively emit red, green, and blue light. The LED unit 122 can thus emit white light by mixing the red, green, and blue light emitted from the individual LED chips. Further, the LED unit 122 and the molded body 123 may be modified to incorporate various shapes. For example, a housing or a printed circuit board may be used for the LED unit 122, and a portion of the molded body 123 may be molded to incorporate a lens shape, or a fluorescent material may be provided inside of the body.

The LEDs 120 respectively mounted on the first and second mounting boards 110a and 110b of the first exemplary embodiment are preferably arranged at regular intervals thereon. However, the arrangement of the LEDs 120 is not limited thereto. For example, the LEDs 120 respectively mounted on each of the first and second mounting boards 110a and 110b may be arranged at regular intervals, respectively, but the interval of the LEDs 120 mounted on the first mounting board 110a may be different from that of the LEDs 120 mounted on the second mounting board 110b. Alternatively, the LEDs 120 respectively mounted on the first and second mounting boards 110a and 110b may each be arranged at different intervals. This is because the number of LEDs 120 mounted on the first mounting board 110a may be different from the number of LEDs mounted on the second mounting boards and 110b, and because the LEDs 120 mounted on the first and second mounting boards 110a and 110b may intentionally be electrically isolated from each other for the emission of light.

Further, in the first exemplary embodiment, the two LEDs 120 respectively mounted on the first and second mounting portions 111a and 111b of the first and second mounting boards 110a and 110b are preferably mounted in line with each other. However, the other LEDs 120 may or may or may not be mounted in the same line. In the particular exemplary embodiment illustrated, the LEDs 120 are arranged in the same line at regular separation intervals and are spaced apart from the light guiding plate 200 disposed inside the housing member 600. The plurality of LEDs 120 may be disposed relatively close to the light guiding plate 200. In one possible embodiment, the light guiding plate 200a may be provided with a concave portion and the LEDs 120 may be inserted in the concave portion.

The LED lamp unit 100, including the first and second mounting boards 110a and 110b on which the LEDs 120 are mounted, and the light guiding plate 200 are accommodated in the housing member 600. The housing member 600 is formed in the shape of a box or a rectangular parallelepiped having an open top surface. That is, as illustrated in FIGS. 1 to 3, the housing member 600 includes a bottom surface 610, a side wall 620 that extends vertically from three edges of the bottom surface 610, and a lamp connecting unit 630 provided at an edge of the bottom tom surface 610. The light guiding plate 200 is received in an accommodating space formed by the lamp connecting unit 630 and the housing side wall 620. The lamp connecting unit 630 is formed with a substantially rectangular, columnar shape having an open interior, and the upper surface of the lamp connecting unit 630 includes a plurality of through-holes 632 therein. The LEDs 120 of the LED lamp unit 100 are arranged to extend through respective ones of the through-holes 632 and into the inner space of the lamp connecting unit 630. Then, as illustrated in FIG. 3, light from the LEDs 120 is directed to the light guiding plate 200 through the open interior of the lamp connecting unit 630. A light reflecting film may be provided on the inner surface of the lamp connecting unit 630. In this embodiment, the first and second mounting portions 111a and 111b of the first and second mounting boards 110a and 110b of the LED lamp unit 100 are preferably adhered to the upper surface 631 of the lamp connecting unit 630 by an adhesive member. That is, the first and second mounting boards 110a and 110b of the LED lamp unit 100 are inverted, i.e., rotated 180 degrees in the direction indicated by the arrows in FIG. 1, before being coupled to the LED lamp connecting unit 610 of the housing member 600.

Since the LED lamp unit 100 is divided into two mounting boards 110a and 110b in this particular embodiment, the assembly of the housing member 600 and the LED lamp unit 100 is greatly facilitated. That is, since a flexible printed circuit board is used for the mounting board 100, when a relatively long mounting board 110 is used (i.e., when the mounting portion thereof is long) as in the prior art, the mounting board 110 may be bent or distorted when it is attached to the lamp connecting unit 630 of the housing member 600. In contrast, in the present exemplary embodiment, a plurality of relatively short mounting boards 110 are attached to the lamp connecting unit 630 of the housing member 600, thereby reducing the probability that the mounting boards 110 will be bent or distorted.

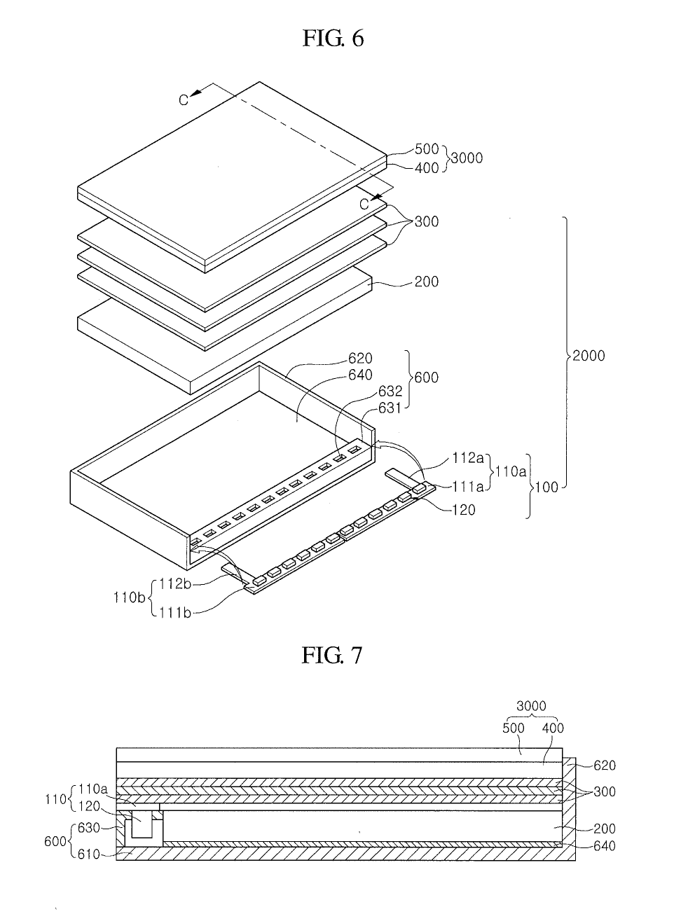

An LCD incorporating the above backlight assembly is described below in connection with FIGS. 6 and 7, wherein FIG. 6 is an exploded perspective view of the exemplary LCD and FIG. 7 is a cross-sectional view of the LCD, as seen along the lines of the section C-C taken therein.

Referring to FIGS. 6 and 7, the exemplary LCD includes a display assembly 3000 and a backlight assembly 2000.

The display assembly 3000 includes a color filter substrate 500, a thin film transistor substrate 400, and a display panel having a layer of a liquid crystal material (not illustrated) interposed between the two substrates. The display assembly 3000 may further include a driving circuit unit and a upper housing member (not illustrated).

The color filter substrate 500 comprises an optically transparent substrate on which RGB pixels are formed by a thin film process, the pixels serving as color pixels that generate selected colors when light passes through them. A common electrode, made of a transparent conductor, such as indium tin oxide (ITO) or indium zinc oxide (IZO), is formed over the entire surface of the color filter substrate 500.

The thin film transistor substrate 400 comprises a transparent glass substrate on which TFTs are formed in the shape of a matrix. Data lines are connected to the source terminals of the TFTs, and gate lines are connected to the gate terminals thereof. Pixel electrodes, formed of a transparent conductive material, are formed on the drain terminals thereof. When an electrical signal is input to the data lines and the gate lines, the TFTs are turned on to apply the electrical signals of the data lines to the pixels via the drain terminals. When power is applied to the gate terminals and the source terminals of the TFT substrate 400 to turn on the TFTs, an electrical field is generated between the pixel electrodes and the common electrode of the color filter substrate 500, thereby causing the alignment of the molecules of the liquid crystal layer between the TFT substrate 400 and the color filter substrate 500 to change selectively. As a result, the light transmittance of respective ones of the pixels is changed in accordance with the changed alignment of the liquid crystal layer therein to produce a desired image on the panel.

A circuit board (not illustrated) may be disposed on the display panel 3000 to supply gate signals and data signals to the gate lines and the data lines of the TFT substrate 400.

Referring to FIGS. 6 and 7, the backlight assembly 6000 includes an LED lamp unit having first and second mounting boards 110a and 110b on which a plurality of LEDs 120 are respectively mounted, a light guiding plate 200 having a side wall disposed adjacent to the LED lamp unit 100, a plurality of optical sheets 300 disposed above the light guiding plate 200, and a housing member 600 within which the LED lamp unit 100, the light guiding plate 200, and the optical sheets 300 are accommodated. A reflective plate 640 may be provided on the bottom surface 610 of the housing member 600, or optionally, may be omitted.

The plurality of optical sheets 300 includes a diffusing sheet, a polarizing sheet, and a luminance improving sheet, and are provided above the light guiding plate 200 to cause the light emitted from the upper surface of the light guiding plate 200 to have a uniform luminance or light distribution. The diffusing sheet directs light incident from the light guiding plate 200 toward the front surface of the liquid crystal display panel 3000, diffuses the light so as to have a uniform distribution over the width and breadth of the panel, and radiates the light onto the panel. The polarizing sheet changes oblique rays of incident light into vertical rays. The luminance improving sheet transmits light parallel to its transmission axis and reflects light perpendicular to the transmission axis. In order to increase transmission efficiency, the transmission axis of the luminance improving sheet 430 preferably corresponds to the polarization axis of the polarizing sheet.

In the particular exemplary embodiment illustrated, the LED lamp unit 100 includes LEDs 120 that emit white light, and first and second mounting boards 110a and 110b on which the LEDs 120 are mounted. The housing member 600 includes a lamp connecting unit 630 having a plurality of through-holes, and the lamp connecting unit is disposed on the upper portion of the housing member 600. The lamp connecting unit is preferably disposed at one side wall of the light guiding plate 200. The first and second mounting boards 110a and 110b are inverted and then attached to the lamp connecting unit 630 such that the LEDs 120 on the mounting boards 110a and 110b extend through respective ones of the through-holes of the lamp connecting unit 630 and into the interior thereof, and are located adjacent to the one side wall of the light guiding plate 200, as illustrated in the cross-sectional view of FIG. 7.

The first and second mounting boards 110a and 110b of the LED lamp unit 100 are connected to an external system that controls the amount of light emitted from the LEDs 120 mounted thereon using different external voltages. With such a configuration, the entire light guiding plate 200 can be controlled not only to have a uniform luminance, but also to have different luminances in the right region and the left region of the light guiding plate 200. This is because the right region with respect to the center of the light guiding plate 200 is disposed adjacent to the first mounting board 110a and the left region is disposed adjacent to the second mounting board 110b. That is, when the same external voltage is applied to the first and second mounting boards 110a and 110b, the LEDs 120 respectively mounted on the first and second mounting boards 110a and 110b emit the same intensity of light to make the respective luminances of the right region and the left region of the light guiding plate 200 the same. In contrast, when different external voltages are respectively applied to the first and second mounting boards 110a and 110b, the LEDs 120 respectively mounted on the first and second mounting boards 110a and 110b emit different intensities of light, thus making the luminance of the right region and the left region of the light guiding plate 200 different from each other. Therefore, it is possible to make image regions in the single display panel have different luminances. That is, when different images are displayed in the single display panel, the regions in which different images are displayed can have different luminances.

Preferably, the exemplary backlight assembly further includes an upper housing member (not illustrated) to protect the components of the display panel 3000 and the backlight assembly 2000 from external impacts and to prevent them from being separated.

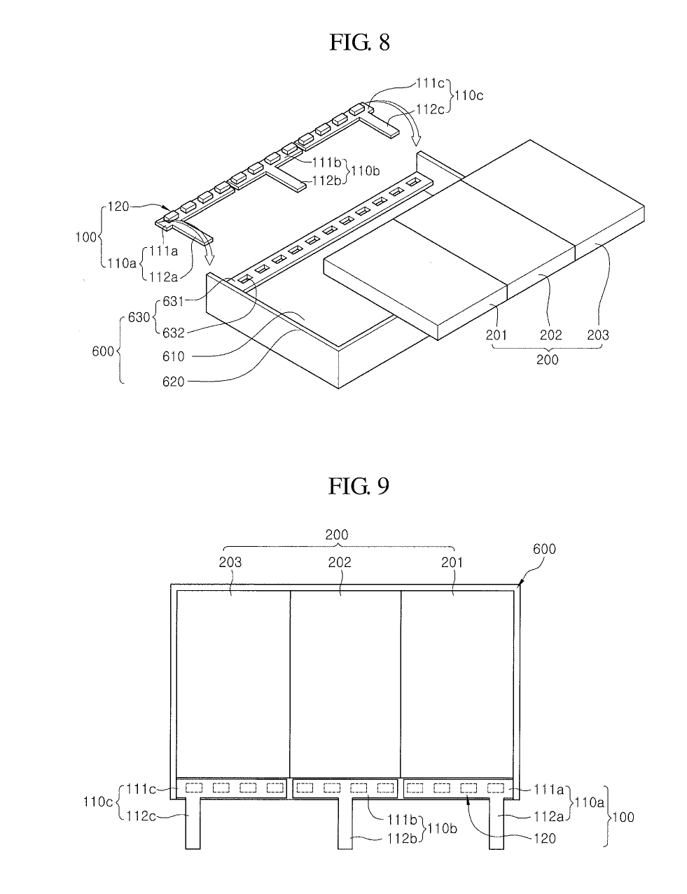

As will be appreciated by those of skill in the art, the configuration of the backlight assembly of the present invention is not limited to that of the first exemplary embodiment described above, but may also have many other advantageous variations. For example, the light guiding plate may be divided into a plurality of light producing regions corresponding to the number of mounting boards of the LED lamp unit. A second exemplary embodiment of a backlight assembly including such a divided light guiding plate and corresponding number of mounting boards is described below in conjunction with FIGS. 8 and 9. Many of the elements of the second exemplary embodiment are the same as or similar to those of the first embodiment described above, and accordingly, further description of these elements is omitted for brevity. Additionally, it should be understood that many of the features and advantages of the second exemplary embodiment described below can be applied to the first exemplary embodiment above.

FIG. 8 is an exploded perspective view of a second exemplary embodiment of a backlight assembly in accordance with the present invention, and FIG. 9 is a plan view thereof. In FIGS. 8 and 9, a backlight assembly according to the second exemplary embodiment includes an LED lamp unit 100 having a plurality of mounting boards 110a, 110b and 110c (generally, 110) on each of which is mounted one or more LEDs 120, and a light guiding plate 200 that is divided into a plurality of regions corresponding to the number of LED mounting boards 110 of the LED lamp unit 100.

The lamp unit 100 of the second exemplary embodiment includes first to third mounting boards 110a, 110b, and 110c, each mounting a group of four LEDs 120. In the particular embodiment illustrated, the first mounting board 110a is disposed in the right region of the housing member 600, the second mounting board 110b is disposed in the center region thereof, and the third mounting board 110c is disposed in the left region thereof. The light guiding plate 200 is divided into first to third light guiding plate portions 201, 202, and 203, each corresponding to an adjacent one of the mounting boards 110. Thus, the first light guiding plate portion 201 is disposed in the right region of the housing member 600 and adjacent to the LEDs 120 of the first mounting board 110a, the second light guiding plate portions 202 is disposed in the center region of the housing member 600 and adjacent to the LEDs 120 of the second mounting board 110b, and the third light guiding plate portion 203 is disposed in the left region of the housing member 600 and adjacent to the LEDs 120 of the third mounting board 110c.

The first to third light guiding plate portions 201, 202, and 203 are applied with light emitted from the groups of LEDs 120 respectively mounted on the first to third mounting boards 110a, 110b, and 110c, so as to emit the light as from a surface light source. In this embodiment, the same level of external voltage may be applied to the first to third mounting boards 110a, 110b, and 110c, or alternatively, different levels of external voltage may be respectively applied thereto. This means that the amount of light emitted from the respective groups of LEDs 120 mounted on the first to third mounting boards 110a, 110b, and 110c may be equal to each other or different from each other, and hence, the optical output from the first to third light guiding plate portions 201, 202, and 203 respectively disposed adjacent to the first to third mounting boards 110a, 110b, and 110c, may be equal to or different from each other. In the embodiment illustrated, the light guiding plate 200 is divided into a plurality of light guiding plate portions 201, 202, and 203 so as to reduce any interference of light from the adjacent light guiding plate portions 201, 202, and 203, but the first to third light guiding plate portions 201, 202, and 203 are preferably disposed close to each other, so as to prevent the formation of dark regions between the adjacent light guiding plate portions 201, 202 and 203.

In accordance with the exemplary embodiments described above, a plurality of mounting boards on which one or more LEDs are mounted can be used as light sources of the backlight assembly. Additionally, defective LEDs can be reworked by replacing only the mounting board on which the defective LED is mounted, thereby simplifying the rework procedure and reducing manufacturing costs. Further, by applying different voltages to respective ones of the LED mounting boards, the luminance of each region of the backlight assembly can be independently controlled.

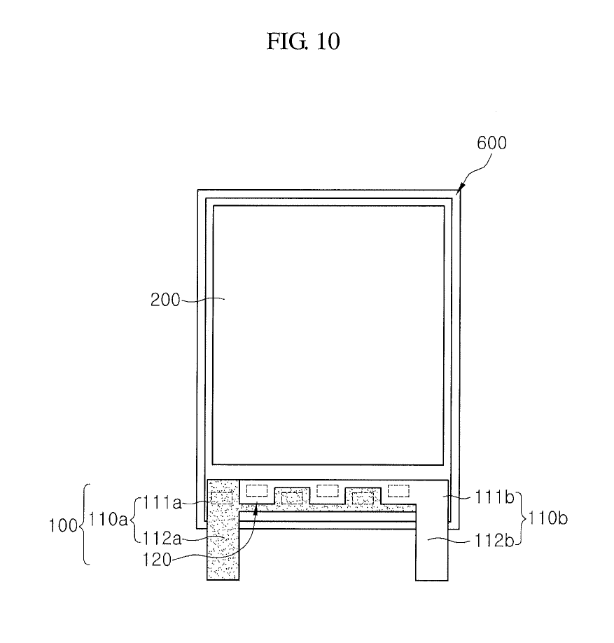

FIG. 10 is an exploded perspective view of a third exemplary embodiment of a backlight assembly in accordance with the present invention.

FIG. 10 shows an arrangement of LEDs on first and second mounting boards 110a and 110b in the backlight assembly of the third exemplary embodiment. The LEDs 120 as point light sources are mounted on the first and second mounting boards 110a and 110b, and disposed to be spaced apart from a sidewall of a light guiding plate 200 by a predetermined distance. Further, the LEDs are alternately arranged on the first and second mounting boards 110a and 110b. That is, in a case where six LEDs 120 are sequentially arranged, first, third and fifth LEDs 120 from left to right of FIG. 10 are mounted on the first mounting board 110a, and second, fourth and sixth LEDs 120 from left to right of FIG. 10 are mounted on the second mounting board 110b. Accordingly, the first and second mounting boards 110a and 110b may have uneven edges being engaged with each other as shown in FIG. 10. The uneven edges of the first and second mounting boards 110a and 110b may have various shapes such as square shape, rectangular shape, etc.

In this configuration, even though the LEDs 120 in one mounting board 110a or 110b may fail during operation, light can be uniformly supplied to the light guiding plate 200 since the other mounting board 110a or 110b is still normally operating. As a result, luminance can be easily controlled.

As those of skill in this art will by now appreciate, many modifications, substitutions and variations can be made in and to LCD backlight assemblies of this invention without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalents.

What is claimed is:

1. A backlight assembly, comprising:
a light source unit, including a plurality of point light sources emitting light and a plurality of mounting boards, each of which has a group comprising at least one of the point light sources mounted thereon;
a light guiding plate disposed adjacent to the light source unit; and,
a housing member in which the light source unit and the light guiding plate are accommodated.

2. The backlight assembly of claim 1, wherein:
the mounting boards comprise printed circuit boards or flexible printed circuit boards, and
each of the mounting boards comprises a mounting portion on which the point light sources are mounted and an extension that extends outwardly from the mounting portions.

3. The backlight assembly of claim 2, wherein the extensions of the respective mounting boards at least partially overlap with each other.

4. The backlight assembly of claim 2, wherein the extensions of the respective mounting boards are disposed adjacent to each other.

5. The backlight assembly of claim 2, wherein the extension protrudes outwardly from the housing member.

6. The backlight assembly of claim 1, wherein:
the mounting boards are disposed adjacent to a first side wall of the light guiding plate;
the length of the one side wall of the light guiding plate is 1 unit length;
the length of each of the mounting boards is between 0.01 to 0.9 unit lengths; and, the total length of the mounting boards is between 0.9 to 1.1 unit lengths.

7. The backlight assembly of claim 1, wherein each group of point light sources mounted on respective ones of the mounting boards is individually driven.

8. The backlight assembly of claim 1, wherein each of the point light sources emits white light, and are electrically connected to the mounting boards in series, in parallel, or both in serial and in parallel.

9. The backlight assembly of claim 1, wherein:
the housing member comprises a housing space that accommodates the light guiding plate and a lamp connecting unit disposed at one edge of the housing space and connected to the light source unit;
the mounting boards are attached to an upper side of the lamp connecting unit; and,
the point light sources of the mounting boards extend through the lamp connecting unit to the interior thereof and are located adjacent to the light guiding plate.

10. The backlight assembly of claim 1, wherein the light guiding plate includes a plurality of light guiding plate portions corresponding in number to the number of mounting boards.

11. The backlight assembly of claim 1, wherein the point light source is a LED.

12. A display device, comprising:
a backlight assembly, including a light source unit having a plurality of mounting boards on which at least one LED emitting light is mounted, a light guiding plate disposed adjacent to the light source unit, and a housing member in which the light source unit and the light guiding plate are accommodated; and,
a display panel that displays images using light emitted from the backlight assembly.

13. The display device of claim 12, wherein the backlight assembly further includes a reflective plate disposed between the housing member and the light guiding plate, and an optical sheet disposed above the light guiding plate.

14. The display device of claim 12, wherein:
each mounting board comprise a printed circuit board or a flexible printed circuit board, and,
each mounting board includes a mounting portion on which the LEDs are mounted and an extension extending outwardly from the mounting portion.

15. The display device of claim 12, further comprising:
at least one LED controller electrically connected to the light source unit for supplying electrical power to the LEDs.

16. The display device of claim 15, wherein:
each mounting board comprise a printed circuit board or a flexible printed circuit board, and,
each mounting board includes a mounting portion on which the LEDs are mounted and an extension extending outwardly from the mounting portion, and,
each of the extensions is respectively connected to the corresponding LED controller.

17. The display device of claim 15, wherein each mounting board is independently supplied with electrical power through a separate LED controller.

18. The display device of claim 12, wherein:
the housing member includes a housing space that accommodates the light guiding plate and a lamp connecting unit that is disposed at one edge of the housing space and connected to the light source unit;
the plurality of mounting boards are attached to an upper side of the lamp connecting unit; and, the LEDs extend through the lamp connecting unit to the interior thereof and are located adjacent to the light guiding plate.
